(19) United States
(12) Patent Application Publication
(10) Pub. No.: US 2006/0181041 A1
(43) Pub. Date: Aug. 17, 2006

(54) Golf bag holder

(76) Inventor: Mark H. Feldman, Miami, FL (US)

Correspondence Address: CASELLA & HESPOS, 274 MADISON AVENUE, NEW YORK, NY, 10016, US

(21) Appl. No.: 11/356,621

(22) Filed: Feb. 17, 2006

Related U.S. Application Data
(60) Provisional application No. 60/653,967, filed on Feb. 17, 2005.

(51) Int. Cl. B62B 1/00

(52) U.S. Cl. 280/47.131

(57) ABSTRACT

A golf bag holding apparatus is provided for mounting to a golf cart. The apparatus permits a golf bag to be rotated towards a substantially horizontal alignment to facilitate access to golf clubs stored in the golf bag.

This application claims priority on U.S. Provisional Patent Appl. No. 60/653,967, file Feb. 17, 2005.

### BACKGROUND OF THE INVENTION

1. Field of the Invention

The invention relates to an apparatus for holding a golf bag at an angle for conveniently accessing the contents of the golf bag.

2. Description of the Related Art

A typical golf bag is a generally tubular structure about three feet long. The bottom end of the golf bag is closed and the top end is open. Pockets generally are formed on opposite sides of the golf bag so that the golfer can carry shoes, balls, tees, towels and other accessories. The interior of the golf bag is used to carry a set of golf clubs. Each golf club has an elongated shaft with a grip at one end and a head at the opposite end. Golf clubs are inserted into the golf bag grip-end first. The golfer will select an appropriate club depending upon the nature of the lie and the distance to the hole. A golfer is likely to use three or four different clubs on each hole, and hence is frequently inserting clubs into the bag and withdrawing clubs from the bag.

Most golf courses offer electrically powered ride-on golf carts, and most golfers utilize the electric golf carts. The percentage of golfers who use electric ride-on golf carts increases directly with the age of the golfer. Older golfers are much more likely to use an electric ride-on golf cart. Golfers who choose not to use an electric ride-on golf cart are likely to use a pull cart.

A typical ride-on golf cart is an open-sided vehicle with three or four wheels and two seats. The floor in front of the seats typically is about 6-9 inches from the ground. The rear end of the golf cart is configured for carrying two golf bags, and has a substantially horizontal bag support disposed at approximately the same height as the floor in front of the seat of the golf cart. The horizontal support might be recessed slightly in a well that is dimensioned to receive the bottom end of the golf bag. A substantially vertical front support is disposed forward of the horizontal support. The vertical support may be generally T-shaped and typically has two slightly concave regions and two belts. The closed bottom end of the golf bag can be placed on the horizontal support of the golf cart. The belt then is wrapped around the golf bag to hold the golf bag in an approximately vertical alignment against the vertical support.

The golfer drives the electric ride-on golf cart around the golf course and periodically retrieves a golf club from the golf bag. The golf club is placed back in the golf bag after each hit.

As noted above, the golf bag typically is at least three feet long and is supported on the horizontal support of the golf cart approximately nine inches from the ground. Hence, the top of the golf bag may be about 45 inches from the ground. Golf clubs vary in length. However, a typical wood is about 45 inches long. As a result, golfers are subjected to inconveniences as they pull the long golf club sufficiently high to clear the elevated top edge of the golf bag supported on the horizontal support of the ride-on golf cart. The golfer experiences a similar inconvenience when the golf club is being reinserted into the golf bag.

The physical inconveniences associated with removing a golf club from an elevated golf bag and reinserting the golf club back into the bag often cause golfers to insert the golf club at an angle to the longitudinal axis of the golf bag and then to gradually pivot the golf club into an alignment along the axis of the golf bag as the insertion of the golf club proceeds. A similar pivoting movement may be used during retrieval of a golf club from the golf bag. This pivoting can cause the grip of the golf club to rub against the rigid top edge of the golf bag or against the rigid dividers within the golf bag. Similarly, this pivoting can cause the top end of the grip to contact the shafts of other clubs in the golf bag. As a result, the grips and shaft are subjected to considerable wear. A similar problem may exist with respect to some pull golf carts that a golfer may use while walking a golf course. However, the bottom end of the golf bag generally is not elevated as much when the golfer uses a pull cart.

Golf courses typically store electric ride-on golf carts in a small secure area of the golf course during the evening and at other times when the golf course is not being used. Some golf cart storage areas are covered to protect the golf carts from the elements. There are economic and practical reasons to minimize the space required for storing golf carts. Thus, golf carts typically are stored in a bumper-to-bumper arrangement in the golf cart storage area of a golf course. Golf carts that require more storage space would not be received very well by golf courses.

Terrain varies widely from one golf course to another and from one location to another on the golf course. Golf courses in Florida, for example, generally have a flat terrain. Golf courses in New England, on the other hand, are likely to have a more hilly terrain. The golf bags should be supported appropriately in a golf cart to ensure stability on the terrain. The substantially vertical alignment of a golf bag on an electric ride-on golf cart ensures stability for virtually all terrain.

The subject invention was developed in view of the above-described state-of-the-art and is intended to provide an easier access to clubs in a golf bag.

Another object of the invention is to ensure stability for the golf bag and golf clubs on the terrain of the particular golf course.

An additional object of the invention is to provide ride-on golf carts that can be stored in an acceptably small space.

### SUMMARY OF THE INVENTION

The subject invention is directed to a golf bag holding apparatus that can be mounted to a ride-on golf cart or a towed golf cart to facilitate the withdrawal and insertion of golf clubs. The apparatus preferably includes a support that can be mounted to a golf cart. The support may be a frame with opposite top and bottom ends. The support may be mounted approximately vertically to a golf cart so that the bottom end of the support is at or near the horizontal support for the golf bag on the golf cart.

The golf bag holding apparatus preferably includes means for mounting the support to the golf cart. The mounting means may be configured to ensure an approximately upright alignment of the support. The attachment means may include one or more straps provided on the support or on the golf cart. However, other mounting means can be provided, such as substantially rigid clamps, bolts or the like.

The golf bag hold apparatus further includes an bed with one end connected privotally to the support and with a portion can figured for nesting reception of the golf bag. The bed may have opposite top and bottom ends. The portion of the bed at or near the bottom end of the bed preferably is mounted pivotally to the support frame at a location at or near the bottom end of the support frame. Thus, the bed can be rotated from a first position where the bed lies substantially within the support frame and one or more additional positions where the top end of the bed is angularly separated from top end of the support frame. Alternatively, the bed may be at least one hook with one end that is connected pivotally to the support and a curved portion that nests with the bag.

The golf bag holding apparatus preferably includes adjustment means for limiting the range of rotation of the golf bag relative to the support. The maximum rotation of the golf bag relative to the support preferably is about 90°. However, the adjustment means preferably permits the bag to be locked releasably in one or more alignments rotated less than 90° from the support.

The bed may include at least one strap and at least one attachment means connectable with a free end of the strap. The strap is dimensioned to wrap around a golf bag when a golf bag is placed on the bed.

The golf bag holding apparatus is mounted to a golf cart so that the support of the apparatus is secured to the golf bag support on the golf cart. The bed is releasably secured in a substantially vertical alignment when the golf cart is not being used. Hence, the bed will not project rearwardly from the golf cart and will not impede storage of the golf cart when the golf cart is not being used.

The apparatus is used by rotating the bed relative to the support and into a position where the bed can support the golf bag substantially parallel to the ground surface on which the golf cart is supported or at an acute angle to the ground surface. The maximum rotational alignment of the bed may be limited by the golf course depending upon the topography of the golf course. More particularly, a golf course with relatively flat terrain may mount the apparatus to permit rotation of the bed into a substantially horizontal alignment. On the other hand, a golf course with a more hilly terrain may limit the rotation of the bed to an acute angle selected in accordance with the maximum grades that are likely to be encountered on the golf course.

A golfer will use the apparatus by rotating the bed away from the support and towards the alignment for substantially horizontal supporting the bag. The golfer then places the bag on the bed and may secure the bag to the bed substantially in the same manner that the golfer would secure the bag to the vertical support on the rear end of the golf cart. However, the golf bag will be aligned substantially horizontally or at an acute angle to the horizontal so that the clubs can be accessed easily.

Golfers may want to avail themselves of the easy access provided by the apparatus even though the golf course may not have their golf carts equipped with the apparatus. In this situation, the golfer can mount his or her own apparatus to the golf cart in much the same way that the golfer mounts a bag to the golf cart. In particular, straps on the golf cart and/or straps on the support can be used to attach the frame to the golf cart. The golfer then rotates the bed into the selected alignment and mounts the golf bag to the bed as described above. In a similar manner, a version of the apparatus can be mounted to a manual golf cart so that the golf bag is aligned for more convenient access to the clubs.

### BRIEF DESCRIPTION OF THE DRAWINGS

FIG. 1 is a side view of a golf cart with the golf bag holding apparatus of the subject invention.

FIG. 2 is a rear elevational view of the frame of the golf bag holding apparatus shown in FIG. 1.

FIG. 3 is a cross-sectional view taken along line 3-3 in FIG. 2.

FIG. 4 is a rear elevational view of the bed of the golf bag holding apparatus.

FIG. 5 is an exploded cross-sectional view taken along line 5-5 in FIG. 4.

FIG. 6 is a cross-sectional view similar to FIG. 5, but showing the bed in an assembled condition.

FIG. 7 is a rear elevational view of the assembled golf bag holding apparatus.

FIG. 8 is a cross-sectional view taking along line 8-8 in FIG. 7.

FIG. 9 is a side elevational view of the golf bag holding apparatus in a first rotational orientation.

FIG. 10 is a cross-sectional view similar to FIG. 9 but showing the golf bag holding apparatus in a second rotational orientation.

FIG. 11 is a front elevational view of a second embodiment of the golf bag holding apparatus.

FIG. 12 is a side elevational view of the apparatus shown in FIG. 11.

### DETAILED DESCRIPTION OF THE PREFERRED EMBODIMENTS

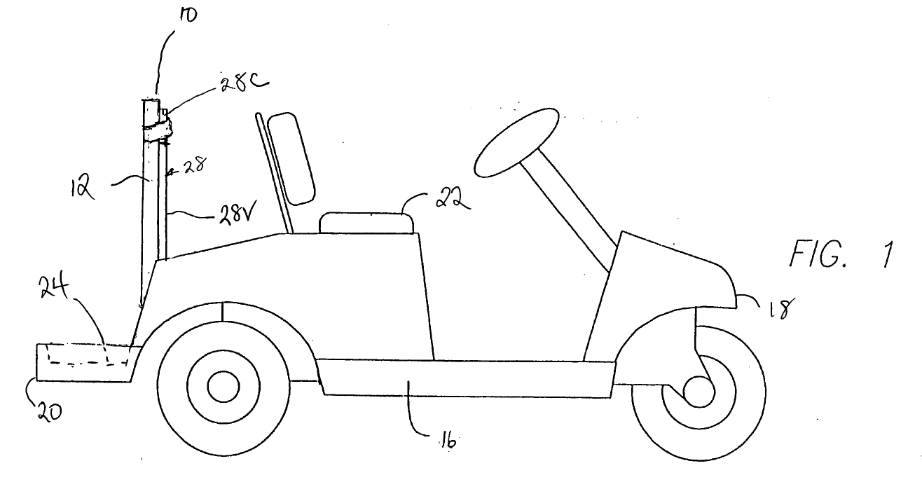

A golf bag holding apparatus in accordance with the subject invention is identified generally by the numeral 10 in FIGS. 1 and 7-10. The golf bag holding apparatus includes and support frame 12 and a bed 14. In the illustrated embodiment, the golf bag holding apparatus 10 is intended for use with a golf cart identified generally by the numeral 16 in FIG. 1. The golf cart 16 has opposite front and rear ends 18 and 20 and a passenger seat 22 between the ends. At least one golf bag well 24 is formed substantially adjacent the rear end 20 of the golf cart 16. The typical golf cart well 24 is approximately 10 inches square and defines a relatively shallow concavity sufficiently deep for supporting the bottom end of a golf bag 26. However, some golf carts have a single well sufficiently wide for accommodating the bottom ends of the two golf bags 26. The golf cart 16 further includes two vertical supports 28 at positions immediately forward of the respective wells 24. The vertical supports 28 may be generally T-shaped or π-shaped with one or two vertical beams 28V and a cross beam 28C. The vertical beams 28V may be tubular columns, while the cross beam 28C may be a plate formed with at least one rearwardly facing concavity for retaining the golf bag 26 thereon. For example, the vertical support 28 may include a belt and buckle assembly that can be wrapped around the golf bag 26 for securing the golf bag 26 in a substantially vertical orientation.

The support frame 12 of the golf bag holding apparatus 10 is substantially rectangular and includes two parallel vertical supports 30 and 32, a top horizontal support 34 and a bottom horizontal support 36, as shown most clearly in FIGS. 2 and 3. The top and bottom horizontal supports 34 and 36 extend between the opposite top and bottom ends of the vertical supports 30 and 32. In a preferred embodiment, the support frame 12 defines a length of about 29 inches and an outside width of approximately 10 inches so that the bottom end of the support frame 12 can be nested in the bag well 24 of the golf cart 16. However, the support frame 12 can have a double width to accommodate two golf bags 26. Portions of the vertical supports 30 and 32 near the bottom horizontal support 36 are formed with pivot apertures 38 and 40 respectively. An inverted U-shaped mounting bracket 42 projects up from a central part of the top horizontal support 34 and is positioned to abut the cross beam 28C of the support 28 on the golf cart 26. Cart mounting straps 44 are mounted to the mounting bracket 42 and can be secured around the cross beam 28C of the vertical support 28 on the golf cart 16 to hold the support frame 12 in position on the golf cart 16.

The bed 14 defines a generally rectangular bed frame 48 dimensioned to nest within the support frame 12. The bed frame 48 of the illustrated embodiment includes side supports 50 and 52, a top support 54 and a bottom support 56. In the illustrated embodiment, the bed frame 48 is provided with a plurality of transverse supports 58 connecting spaced apart locations on the side supports 50 and 52. The top support 54 and the traverse supports 58 preferably are nonlinear and define a concave shallow V-shape or U-shape configured for nested reception of the golf bag 26. The bottom support 26 is either linear or has a non-linear shape oriented oppositely from the top support 54 and the transverse supports 58. Thus, the bottom of the golf bag 26 can be supported on the bottom support 56 while the side of the golf bag 26 is nested with the top support 54 and the transverse supports 58.

Bag straps 60 and 62 extend from the side supports 50 and 52, and a buckle 64 is provided on the end of the bag strap 62. Pivot apertures 66 and 68 are formed in the side supports 50 and 52 of the bed frame 48 and can be aligned with the pivot apertures 38 and 40 in the support frame 12.

The bed 14 optionally may include a bag support 72 mounted to the bed frame 48. The optional bag support 72 may be formed from a resilient waterproof material such as polyurethane that may be color coordinated with the remainder of the golf bag holding apparatus 10. Additionally, the optional bag support 72 preferably is sufficiently soft and smooth to avoid scratching the surface of the golf bag 26.

The golf bag holding apparatus 10 is assembled by nesting the bed 14 in the support frame 12 and then mounting pivot pins 74 and 76 through the registered pivot apertures 38, 40, 66 and 68. Links 78 are connected pivotably between the support frame 12 and the bed 14 at locations spaced from the pivot pins 74 and 76. The links 78 may be pivotal, flexible and/or adjustable. The mounting of the pivot pins 74 and 76 and the links 78 typically will be carried out at a place of manufacture so that the golf bag holding apparatus 10 can be sold to a consumer in a fully assembled condition. The support frame 12, the bed frame 14 and the bag support 72 all are formed from very lightweight material, e.g. aluminum or stainless steel so that the entire golf bag 10 holding apparatus can be constructed to have a total weight of no more than about five pounds.

The golf bag holding apparatus 10 is secured to the golf cart. More particularly, in the illustrated embodiment, the bottom horizontal support 36 of the support frame 12 is nested into the bag well 24 on the golf cart 16. The cart mounting straps 44 then are wrapped around both the U-shaped mounting bracket 42 and the cross beam 28C of the vertical support 26 of the golf cart 16. The cart mounting strap 44 may secured by a buckle 46 or by a VELCRO® attachment. This mounting procedure is appropriate for those circumstances where the golfer is carrying his own golf bag holding apparatus 10 to the golf course for mounting on the golf cart 16. In situations where the golf course retrofits all of their golf carts 16 with the golf bag holding apparatus 10, a more permanent attachment can be employed by using brackets, bolts or the like.

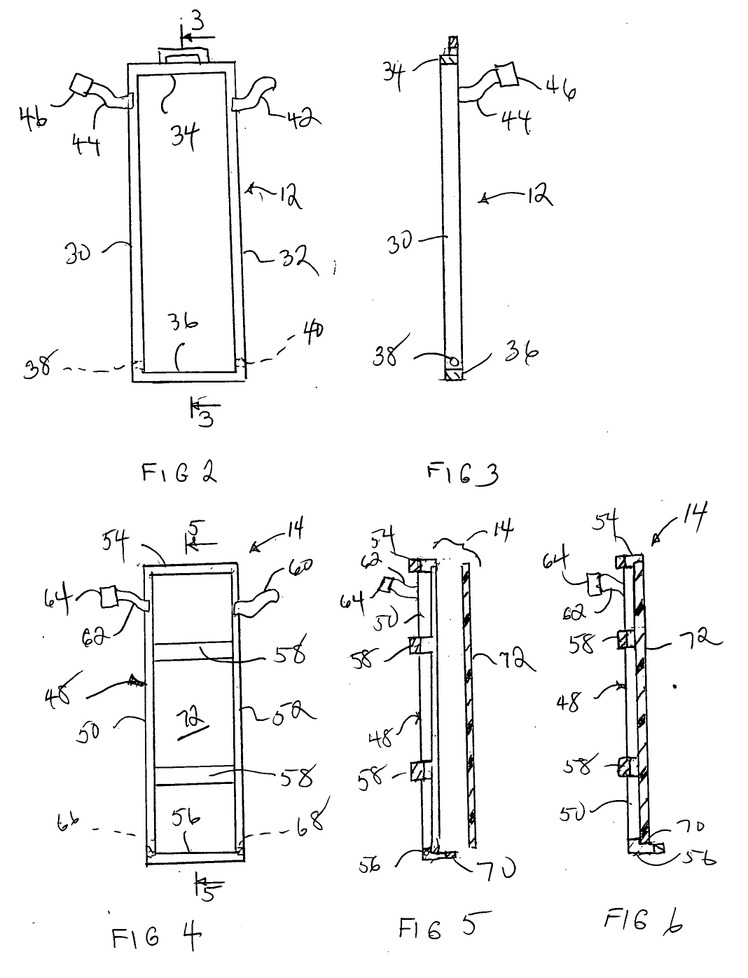

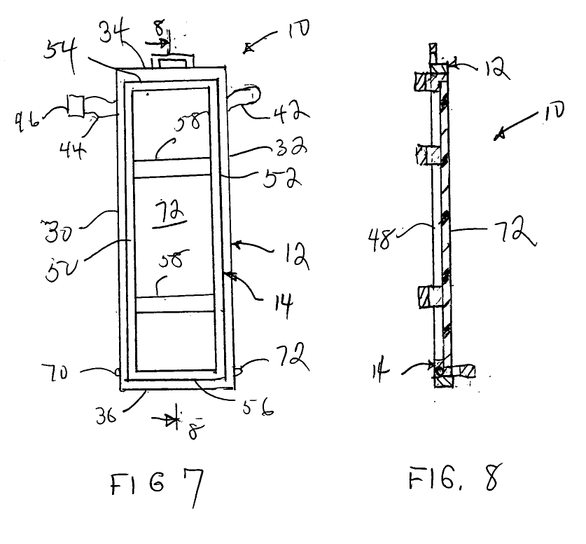

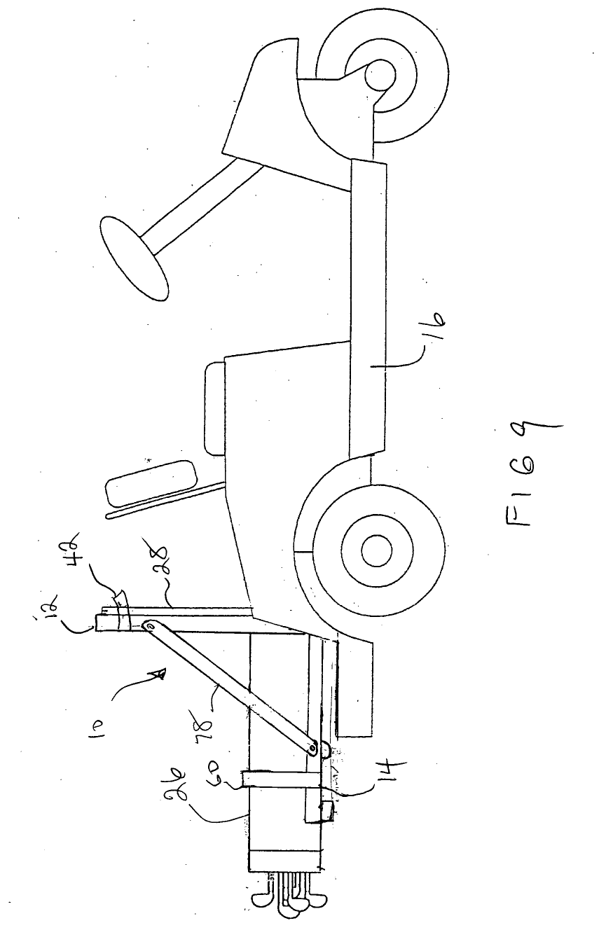

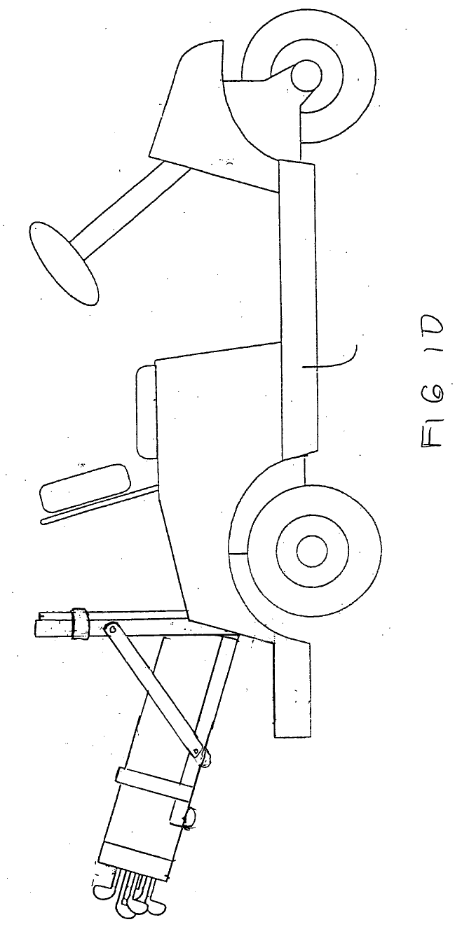

The golfer then rotates the bed 14 from the substantially vertical orientation shown in FIG. 1 to an angular orientation as shown in FIG. 9 or 10. FIG. 9 shows the bed 14 rotated approximately 60° from the vertical alignment of the support frame 12. FIG. 10 shows the bed 14 aligned substantially perpendicular to the vertically aligned support frame 12. The FIG. 9 orientation is more appropriate for a golf course that is hilly. The FIG. 10 orientation is more appropriate for a golf course that is more flat. The golf bag 26 is mounted on the bed 14 and is held in position by securing the free end of the bag strap 60 to the buckle 64. With either the FIG. 9 or FIG. 10 orientation of the bed 14, the clubs in the golf bag 26 are more easily accessible without excessive reaching or stretching by the golfer. Additionally, golf clubs can be slid linearly into or out of the golf bag without a pivoting movement that would be required with the golf bag in the orientation shown in FIG. 1.

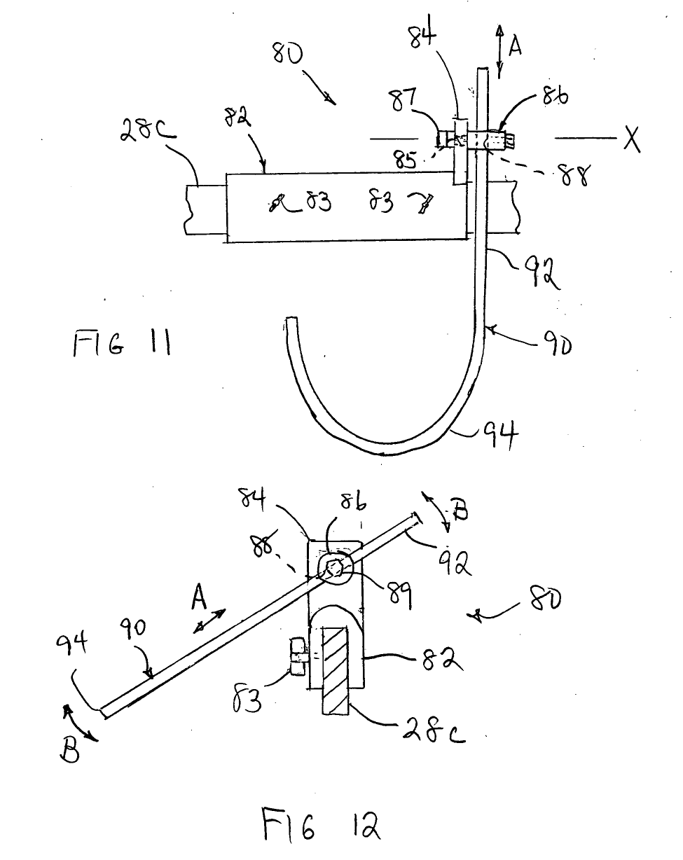

An alternate embodiment of the golf bag holding apparatus is identified by the numeral 80 in FIGS. 11, and 12. The apparatus 80 includes a mounting bracket 82 for mounting to the cross beam 28C of the vertical support 28 on the golf cart 16. More particularly, the mounting bracket 82 is a channel with an inverted U-shaped cross section. Bolts 83 or similar fastening means extend through the mounting bracket 82 for securely engaging the mounting bracket 82 to the cross beam 28C.

A mounting flange 84 extends up from one end of the mounting bracket 82, and is formed with a through hole 85 that extends generally parallel to the longitudinal direction of the channel defined by the mounting bracket 82. An adjustable swivel mount 86 is mounted to the through hole 85 of the mounting flange 84. More particularly, the swivel mount 86 is rotatable about an axis X extending generally parallel to the longitudinal direction of the channel defined by the mounting flange 82, and hence generally parallel to the axes about which the wheels of the golf cart 16 rotate. The swivel mount 86 includes a threaded member 87 to tighten the swivel mount 86 to the mounting flange 84 at a selected rotational orientation about the axis X. Additionally, the swivel mount 86 includes an aperture 88 extending transversely therethrough and perpendicular to the axis X. However, the orientation of the aperture 88 can be changed as the swivel mount 86 is rotated about the axis X. A lock bolt 89 extends into the swivel mount 86 perpendicular to the axis X so that a leading end of the lock bolt 89 can be advanced into the aperture 88.

The apparatus 80 further includes a generally J-shaped hook 90 with an elongate straight section 92 and a curved section 94. The straight section 92 is dimensioned to be passed through the aperture 88 and the swivel mount 86 along direction A. The curved section 94 of the J-shaped golf bag hook 90 is dimensioned to partly surround the outer peripherally of a golf bag. The golf bag hook 90 held at a selected longitudinal position (direction A) in the aperture 88 of the swivel mount 86 by tightening the lock bolt 89.

The apparatus 80 is used by securing the mounting bracket 82 to the cross beam 28C of the golf cart 16. The golf bag support 90 then is adjusted with and in the swivel support 86. More particularly, the straight section 92 of the golf bag support 90 is moved along its longitudinal axis A to an appropriate position in the mounting aperture 88 of the swivel support 86, while the swivel support 86 is rotated about its own axis X to adjust the angular alignment of the golf bag support hook 90, as indicated by the arrow B in FIG. 12. The golf bag 26 then merely is positioned with the bottom end of the golf bag 26 in the well 24 of the golf cart 16 and with an outer peripheral side surface of the golf bag 26 supported by the curved section 94 of the golf bag support hook 90. The adjustment of the golf bag support 90 in the longitudinal direction A of the straight section 92 and in the angularly direction indicated by the arrow B will positioned the golf bag 26 at an appropriate position relative to the horizontal as shown with respect to the first embodiment in FIGS. 9 and 10.

The second embodiment of the apparatus 80 depicts a single J-shaped golf bag support hook 90. However, a variation of the second embodiment could provide two J-shaped golf support hooks 90 mounted respectively to two mounting brackets 84 secured on opposite ends of the channel-shaped mounting bracket 82. Alternatively, a single U-shaped golf bag support could be mounted with two flanges 84 and to swivel supports 86, as described above.

The apparatus 80 of the second embodiment provides all of the advantages of the first embodiment. However, the apparatus 80 of the second embodiment can be smaller and lighter than the apparatus of the first embodiment.

While the golf bag holding apparatus has been described and illustrated with respect to a preferred embodiment, various changes can be made without departing from the scope of the invention. For example, the bottom horizontal support 40 of the support frame 12 can project rearwardly from the vertical supports 34 and 36 and can have dimensions to nest in the wells of the golf cart. Additionally, as noted briefly above, other attachments can be provided for securing the support frame 12 to the golf cart. Still further, other arrangements can be provided for securing the golf bag to the bed and other linkages (e.g. cables, straps) can be provided for limiting the range of rotation of the bed 14 relative to the support frame 12. Still further, the golf bag holding apparatus 10 can be adapted for mounting to a manual cart. The bed need not have the bag support 72 and/or the transverse supports 58. Thus, the bed frame 48 can be mounted around the support frame 12.

What is claimed is:

1. A golf bag holding apparatus for use with a golf cart, said apparatus comprising:
a support frame for mounting to the golf cart;
a bed having opposite top and bottom ends, portions of the bed near the bottom end being pivotally connected to the frame so that portions of the bed near the top end of the bed can be pivoted away from the support frame and towards a substantially horizontal alignment; and
at least one link extending between the support frame and the bed at a location spaced from the pivotal connection of the bed to the support frame for limiting rotation of the bed relative to the support frame.

2. The golf bag holding apparatus of claim 1, wherein the link is adjustable to provide a plurality of optional ranges of pivotal movement of the bed relative to the frame.

3. The golf bag holding apparatus of claim 2, wherein the at least one link comprises at least one strap.

4. The golf bag holding apparatus of claim 2, wherein the at least one link comprises at least one cable.

5. The golf bag holding apparatus of claim 2, wherein the at least one link comprises first and second links.

6. The golf bag holding apparatus of claim 1, wherein the support frame is substantially rectangular and includes a bottom support for substantially fixed supporting engagement on a horizontal surface of the golf cart, side supports extending substantially rigidly from the bottom horizontal support and a top support connecting locations on the side supports spaced from the bottom support.

7. The golf bag holding apparatus of claim 6, wherein the support frame includes cart attachment means for attaching top portions of the support frame to a vertical support of the golf cart.

8. The golf bag holding apparatus of claim 7, wherein the cart attachment means comprise at least one strap.

9. The golf bag holding apparatus of claim 7, wherein the bed is configured for rotation into substantially nested engagement with the support frame.

10. The golf bag holding apparatus of claim 1, wherein the bed includes a frame having top and bottom supports and side supports extending between the top and bottom supports, the bottom supports being configured for supporting a bottom end of the golf bag and the top support being configured for supporting a side surface of the golf bag.

11. The golf bag holding apparatus of claim 10, wherein the top support is nonlinear and has a concave side for nested reception of the golf bag.

12. The golf bag holding apparatus of claim 11, further comprising at least one transverse support extending nonlinearly between the top and bottom supports and being configured for nested reception of the golf bag.

13. A golf bag supporting apparatus for use with a golf cart, said apparatus comprising a mounting bracket for secure attachment to the golf cart, and a hook-shaped golf bag support having a substantially straight section adjustably mounted to the mounting bracket and a curved section configured for supporting the golf bag.

14. The apparatus of claim 13, wherein the straight section of the golf bag support is adjustable in an axial direction of the straight section of the golf bag support and is angularly adjustable on the bracket into a plurality of angular positions relative to a surface on which the golf cart is supported.
